(19) United States
(12) Patent Application Publication
(10) Pub. No.: US 2006/0026941 A1
(43) Pub. Date: Feb. 9, 2006

(54) Mower deck cleaning and lubricating device

(76) Inventor: Joseph P. Iannello, Corfu, NY (US)

Correspondence Address: BASCH & NICKERSON LLP, 1777 PENFIELD ROAD, PENFIELD, NY, 14526, US

(21) Appl. No.: 10/910,393

(22) Filed: Aug. 3, 2004

(51) Int. Cl. A01D 19/00

(52) U.S. Cl. 56/16.8

(57) ABSTRACT

A device applies a liquid to clean the underside of a mowing deck. The device uses a hollow body, an inlet, a plurality of outlet apertures, a liquid passageway and a clamp assembly to apply liquid to the underside of a mowing deck. A brush, attached to a cutting blade, is also used to clean the underside of a mowing deck.

### FIELD OF THE INVENTION

1. Background of the Invention

A mowing device such as a lawnmower, riding lawn mower or lawn tractor has the tendency to accumulate cut grass debris on both the underside and the topside of the mowing deck. The accumulation of such debris can impede the proper performance of the mowing device, and can also create maintenance problems such as the increased probability of oxidation of the mowing deck.

Often times the operator of the mowing device will clean the underside of the mowing deck using a scraper or stiff brush. This involves tipping the mower to access the underside of the mowing deck, or removal of the mowing deck entirely. This cleaning procedure is prone to problems. If the mower can be tipped, the procedure involves the likelihood of fuel and oil leaking from the mower, creating both a safety and an environmental hazard. For larger mowing decks that cannot be readily tipped, the cleaning procedure involves the physical removal of the mowing deck; a procedure that is time consuming and requires a great deal of physical effort. Once the underside of the mowing deck is exposed, the removal of accumulated cutting debris is accomplished by scraping or brushing the underside of the mowing deck. This also exposes the operator to the risk of personal injury from the cutting blade or blades.

2. Brief Description of the Prior Art

Various devices are proposed in the prior art to clean a mowing deck while the deck remains in an upright and unaltered position. These devices commonly use only water as the cleaning agent. Many of these devices are attached to the ground, and the mower is placed over the device. Such devices are described, for example, in U.S. Pat. No. 5,651,242 entitled LAWN MOWER CLEANING DEVICE, U.S. Pat. No. 3,856,028 entitled MOWER CLEANING APPARATUS, U.S. Pat. No. 5,312,047 entitled LAWN MOWER WASHER RING, and U.S. Pat. No. 5,673,856 entitled LAWN MOWER CLEANING DEVICE AND METHOD OF MAKING SAME. These devices require various size cleaning fixtures to accommodate the multitude of mowing deck sizes and shapes on the market today. In addition, should the device come into contact with the spinning blades, the device will be destroyed, and damage to the blades may result. Another device, as described in U.S. Pat. No. 6,581,363, uses water as the cleaning agent and is attached to the mowing deck by drilling a hole through the top of the mowing deck and attaching a water nozzle to the hole. This approach is time consuming to install, can weaken the structural strength of the mowing deck, and also represents a potential safety hazard should the nozzle vibrate loose and drop into the rotating blades. Also, many mowing decks contain integral belts and pulleys on the top surface of the mowing deck, and the placement of a nozzle amongst this assemblage of pulleys and belts creates a potential safety risk. The present invention improves on the prior art in that it can be used with any size or shape mowing deck, does not require attachment to the ground, cannot be drawn into the cutting blades, does not require cutting, drilling or modification to the mowing deck, and can be used with an optional mechanical brush attachment to aggressively remove accumulated grass debris. In addition, the present invention can be used with an optional fan attachment to reduce the accumulation of debris on the top side of the mowing deck. The present invention may also be used to lubricate and rustproof a mowing deck.

### SUMMARY OF THE INVENTION

One embodiment of the present invention involves a device for applying liquid to an underside of a mowing deck. The device comprises a hollow body having an inlet, a plurality of outlet apertures, a passageway for communicating liquid, and a clamp assembly.

Another embodiment of the invention might include a mechanical cleaning device for mounting on a cutting blade comprising an expandable metal clamp, at least one bolt to constrict said metal clamp, and a replaceable brush head.

Another embodiment of the invention includes a cleaning and cooling device for mounting to a drive shaft comprising a yoke assembly for mounting to said drive shaft, at least two flexible fan blades that are mechanically attached to said yoke assembly, and at least one bolt to attach said yoke assembly to said drive shaft.

Still another embodiment of the invention is a method for cleaning a mowing deck.

Still another embodiment of the invention is a method for lubricating a mowing deck.

### BRIEF DESCRIPTION OF THE DRAWINGS

FIG. 1 is a top plan view of the first cleaning element of the present invention;

FIG. 2 is a side elevational view of the cleaning apparatus of FIG. 1;

FIG. 3 is a detail view of an inlet coupling for connection with a quick release garden hose coupling;

FIG. 4 is a plan view of the second cleaning element of the present invention;

FIG. 5 is a plan view of the base structure of the second cleaning element of FIG. 4;

FIG. 6 is a plan view of the replaceable cleaning brush of the cleaning apparatus of FIG. 4;

FIG. 7 is a top view of the second cleaning element of the present invention shown attached to a mowing blade;

FIG. 8 is a side elevational view of the second cleaning element of the present invention shown attached to a mowing blade;

FIG. 9 is a top plan view of one embodiment of the third cleaning element of the present invention shown in the closed position;

FIG. 10 is a top plan view of one embodiment of the third cleaning element of the present invention shown in the open position;

FIG. 11 is a top plan view of another embodiment of the third cleaning element of the present invention; and

FIG. 12 is a top plan view of yet another embodiment of the third cleaning element of the present invention.

### DESCRIPTION OF THE PREFERRED EMBODIMENTS

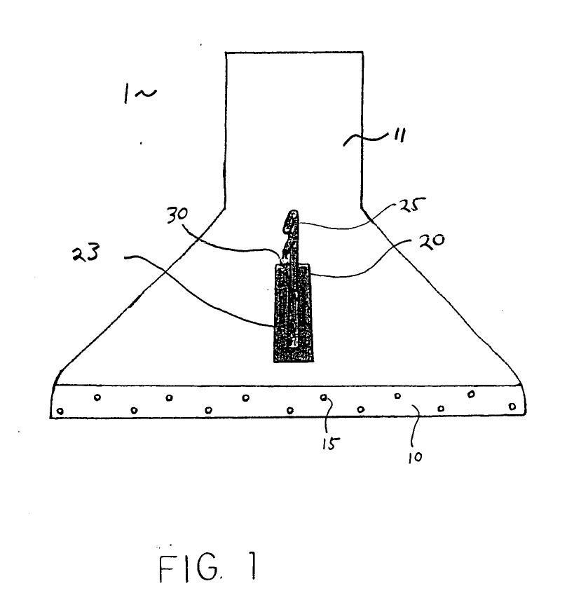

An apparatus 1 is illustrated in FIG. 1 for cleaning and lubricating the underside of a mowing deck of a garden tractor, riding lawn mower, lawn mower or other agricultural cutting equipment. The body 11 of the apparatus 1 is generally hollow to allow the flow of water from a water source such as a garden hose through the body 11 and out a series of apertures 15. Optionally a cleaning fluid or lubricating oil may be dispensed from a source of cleaning fluid or lubricating oil such as a dispenser or container with a hose connection. The series of apertures 15 allow for the delivery of fluid when the hollow body 11 is connected to a source of fluid such as water or oil. The series of apertures 15 are narrow to allow for high pressure delivery of fluid. The quantity of apertures may vary depending on the size of the mowing deck. The angle at which the apertures 15 deliver fluid can be controlled by both the shape of the aperture as well as the surface 10 that contains the apertures. The width of the surface 10 is between 114.3 to 152.4 mm. (4.5 to 6 inches). The angle of water delivery will typically be between 30 and 90 degrees with the horizontal plane. Each aperture may be round, oblique, oval, multi-sided, or built up in a nozzle configuration.

The body 11 is attached to the underside of a mowing deck using a clamp assembly 20 that is mechanically fastened to the body 11 using techniques commonly known to one skilled in the art. These techniques may include rivets, screws, bolts, glue and the like. The clamp assembly 20 is made from a metal such as aluminum, steel, brass, and the like. The clamp assembly 20 allows the cleaning and lubricating apparatus 1 to be attached to the underside of the mowing deck by inserting the downward metal flange of a typical mowing deck between the two forked elements 25 of the clamp assembly 20. The clamp assembly 20 allows the apparatus 1 to extend up to 76.2 mm (3 inches) under the mowing deck. Once the cleaning and lubricating apparatus 1 is placed under the mowing deck in a position acceptable to the operator of the device, the thumbscrew 30 is tightened onto the flange of the mowing deck, forcibly fastening the forked elements 25 of the clamp assembly 20 to the mowing deck flange. The thumbscrew may include a nylon insert, a set screw, thread locking material, a lock washer or other component to prevent said thumbscrew from becoming loose. Such components are known to those skilled in the art. The clamp assembly 20 may also optionally be adjustable in both the horizontal plane and the vertical plane to allow the operator of the device to optimize the placement of the device under the mowing deck.

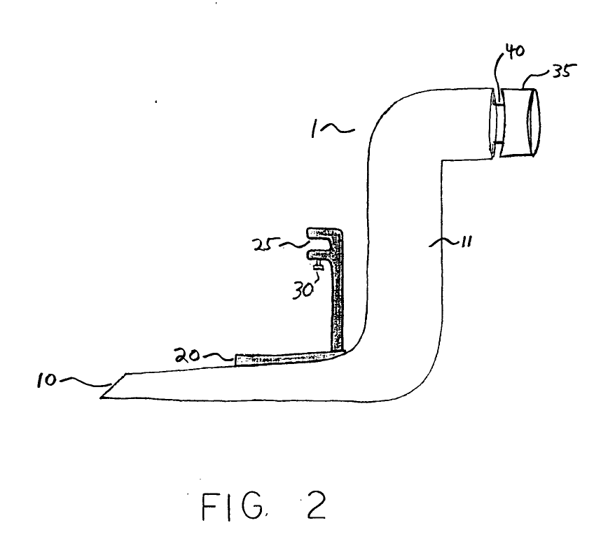

Referring now to FIG. 2, a side elevational view of the cleaning apparatus 1 is shown. The apparatus contains a hose fitting 35 that may be a threaded garden hose style fitting, a quick release hose fitting, a water shut-off fitting, a threaded fitting, or a custom fitting. The hose fitting may be made of either metal or plastic. The hose fitting 35 is connected to the body of the apparatus 11 using a transitional connector 40 that allows for permanent attachment of the transitional connector 40 to the body of the apparatus 11. The transitional connector 40 is made of either a plastic or a metal, and is permanently attached to the body of the apparatus 11 using an adhesive, plastic welding, or a mechanical fitting such as a barbed fitting or a threaded fitting. The transitional connector 40 allows one to change the hose fitting 35 to a different style that may be more suitable to the application; such as changing the fitting from a garden hose fitting to a quick connect fitting.

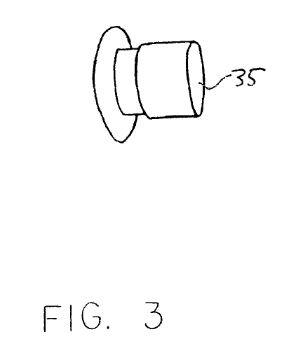

FIG. 3 shows in more detail the hose fitting 35, and the termination of the hose connector to the transitional connector 40. The transitional connector 40 may also contain a narrowed or modified flow channel to restrict or change the flow of liquid traversing the transitional connector.

The method of manufacturing the apparatus 1 involves the simple assembly of several plastic and metal parts. The body 11 is made of plastic, and is readily made by one skilled in the art. The body 11 is drilled with a plurality of fine holes 15 along the angled edge 10. The drilled holes may be round, oblique, geometric, or built up in a nozzle configuration. The body 11 is then drilled on the top surface with several holes sufficient to allow the attachment of the clamp assembly 20 using screws, rivets, glue or other fasteners known to one skilled in the art. The clamp assembly is made of a metal, and is fabricated either by machining or casting. The transitional connector 40 is then attached to the appropriately sized opening in the body 11 using threads, barbs, glue or welding techniques. The hose fitting 35 is finally threaded to the transitional connector 40.

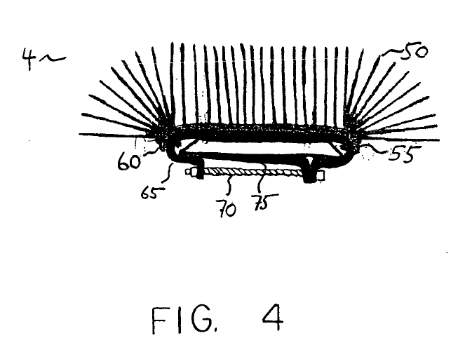

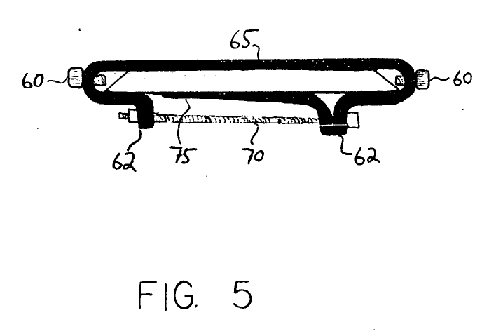

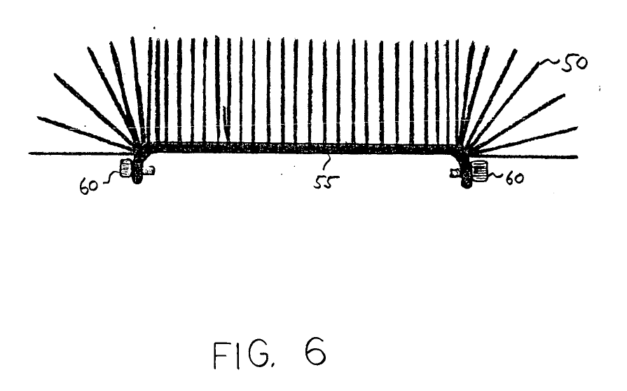

FIG. 4 shows a cleaning brush 4 that is attached to a mowing blade to optionally provide mechanical cleaning to the underside of a mowing deck. The cleaning brush 4 may be used in conjunction with the cleaning apparatus 1 to remove built up layers of cutting debris that are difficult to remove by pressurized water alone. The cleaning brush 4 contains two main assemblies, a permanent metal body 65 and a replaceable brush head 50. Both of these two main assemblies are shown separately in FIGS. 5 and 6 respectively. The replaceable brush head 50 allows one to replenish the mechanical cleaning function of the cleaning brush 4 at low cost. The replaceable brush head 50 further allows a variety of different brush heads to be used, dependent on the application. For example, the replaceable brush head may contain bristles that are made of stiff monofilament, or may contain bristles made of a metal. Different material properties such as stiffness and durability may be incorporated into a variety of brush heads that the operator may chose from. The replaceable brush head 50 is mounted to the permanent metal body 65 using two or more bolts 60. Each bolt 60 passes through a hole in the replaceable brush head 50 and terminates in a threaded fitting on the permanent metal body 65. To replace the brush head 50, one merely unscrews the attachment bolts 60, removes the old brush head 50, and attaches a new brush head by reversing the disassembly process. The bolts 60 may also contain a lock washer, locking thread compound, a nylon insert or other material to prevent the bolt from vibrating loose. The bolts 60 are properly torqued to reduce the occurrence of such loosening.

Referring now to FIG. 5, the permanent metal body 65 that makes up one of the two major assemblies of the cleaning brush 4 is shown. The permanent metal body 65 may be made from aluminum, steel, brass, stainless steel, titanium or the like. The permanent metal body 65 is made as an expandable loop 75 with two flanges 62 to accommodate a threaded bolt 70. The threaded bolt 70 is preferably made of hardened steel to withstand high bolt torque. The permanent metal body 65 is placed over the end of a mowing blade, and the bolt 70 is tightened so that the metal body 65 constricts around the mowing blade, and provides mechanical attachment of the cleaning brush 4 to the mowing blade. The threaded bolt 70 is properly tightened so that the cleaning brush 4 remains on the mowing blade while the mowing blade is rotating during the cleaning process. The permanent metal body 65 is formed from metal that has undergone the secondary operation of drilling holes to accommodate bolt 70 and drilling and threading holes to accommodate bolts 60.

FIG. 6 shows the replaceable brush head 50. The brush head is made from a metal or plastic base 55 that is shaped so as to conform to the upper surface of the permanent metal body 65. The base 55 is drilled with a plurality of holes that receive bristles 50. The bristles 50 are made of stiff monofilament similar to that used in commercial string trimmers. The replaceable brush head may optionally be made entirely of plastic. The bristles 50 may optionally be made of a metal. The bristles may optionally be shaped such that the end of each bristle is bent at a ninety degree angle. The replaceable brush head 50 contains two or more bolts 60 that are used to attach the replaceable brush head 50 to the permanent metal body 65.

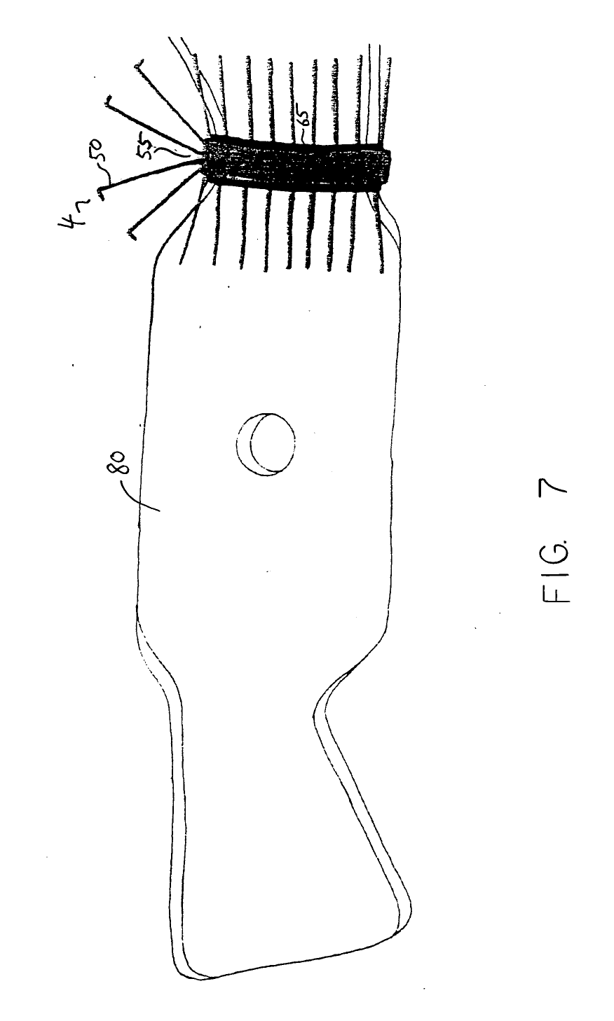

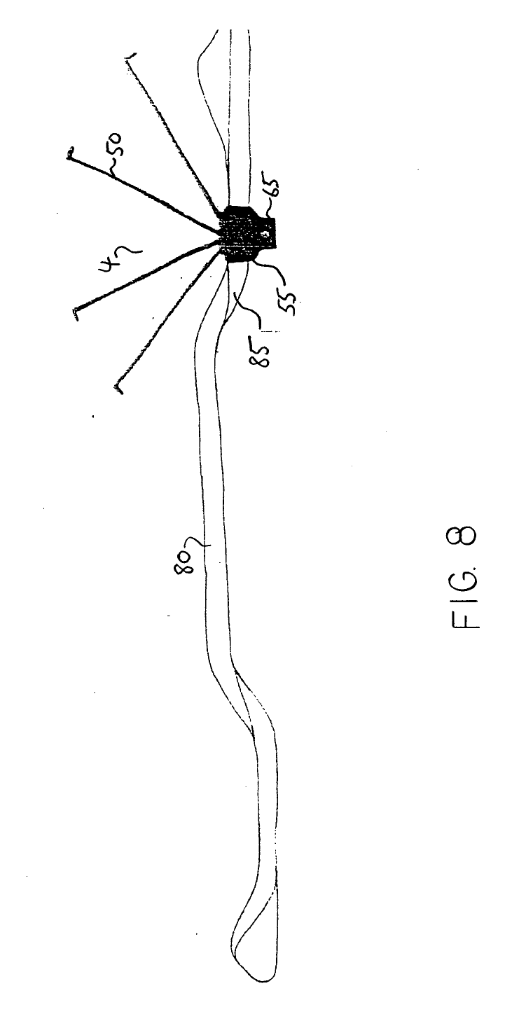

In use, the cleaning brush 4, as shown attached to a mowing blade in FIG. 7, is inserted over the end of a mowing blade 80 and placed at a point along the length of the mowing blade where there is a change in the width of the mowing blade 80. This placement point may vary by mowing blade manufacturer, but will be a point at which the cleaning brush 4 is to be attached to the mowing blade 80 and will provide a secure resting point for the cleaning brush 4. Another point at which the cleaning brush 4 may be terminated along the length of the mowing blade 80 is a point along the length of the blade where the elevation of the blade changes. This is indicated in FIG. 8 as location 85. One may place a cleaning brush 4 on either end of the mowing blade, or optionally use two or more cleaning brushes for each mowing blade. Once the cleaning brush 4 is in a proper position along the length of the mowing blade 80, the bolt 70 shown in FIGS. 4 and 5 is tightened. The bolt 70 is tightened so that the metal body 65 constricts around the mowing blade, and provides mechanical attachment of the cleaning brush 4 to the mowing blade.

Once the cleaning brush 4 is securely attached to the mowing blade 80, the operator of the device will apply power to the mowing deck, allowing the blades to rotate the cleaning brush 4 around the underside of the mowing deck. The operator may elect to use apparatus 1 to deliver a high pressure spray to the underside of the mowing deck in conjunction with the mechanical cleaning action of the cleaning brush 4. The operator of the device will operate the brushes, and observe from a safe position the ejection of cutting debris from the underside of the mowing deck. Once the operator notices that the quantity of debris being ejected from the underside of the mowing deck has significantly decreased or stopped, the operator can assume that the cleaning process is complete, and will turn off the power to the mowing deck and turn off the water supply to apparatus 1.

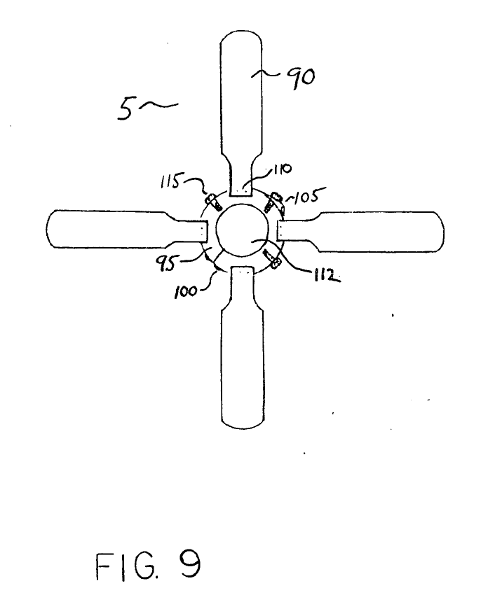

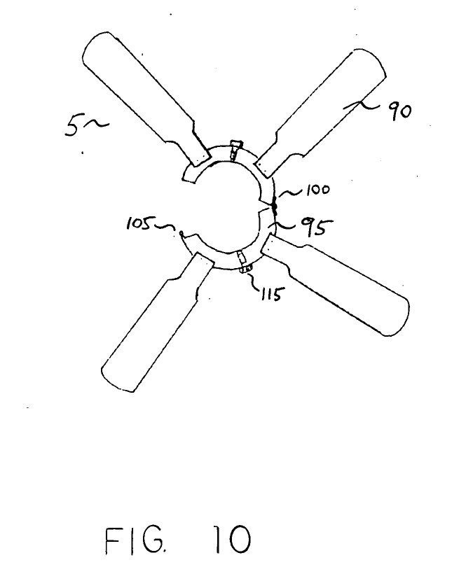

FIGS. 9, 10, 11 and 12 show various variations of a device to clean accumulated cutting debris from the topside of a mowing deck. The device uses the movement of air to clean and remove accumulated cutting debris from the top side of a mowing deck using fan blades 90. The fan blades 90 are made of a soft material such as rubber to absorb impact in the event that the fan blades 90 come into contact with another object. This improves the safety of the air cleaning device. The movement of air with the fan blades 90 also provides additional cooling to the motor of the cutting device. FIG. 9 shows the air cleaning device 5 with a hinged yoke to allow fastening to a drive shaft or spindle. FIG. 9 shows the hinged yoke in a closed position, and FIG. 10 shows the hinged yoke in an open position. The yoke 95 connects the fan blades 90 to a drive shaft, and is made of a metal such as hardened steel, stainless steel or titanium. The yoke 95 contains a hinge 100 that allows the yoke to open. The yoke 95 also contains a latch 105 that secures the yoke 95 in a closed position around the drive shaft or spindle. The yoke 95 contains an opening 112 to accommodate a drive shaft or spindle. The diameter of the opening 112 may be slightly smaller than the drive shaft diameter, or the opening 112 may contain knurls or surface texture to ensure proper friction fit between the yoke 95 and the drive shaft or spindle. The yoke 95 also contains bolts 115 contained in threaded holes that traverse the diameter of the yoke 95 and make contact with the drive shaft or spindle upon which the yoke is attached. The bolts 115 are tightened once the yoke 95 is closed and latched, and serve to apply pressure to the drive shaft or spindle and thus secure the air cleaning device 5 to the drive shaft or spindle. The bolts 115 are preferably made from hardened steel to withstand high bolt torque. The flexible fan blades 90 are attached to the yoke 95 with metal fasteners 110 such as bolts, rivets or screws. The metal fasteners 110 contain a head of sufficient size and shape as to prevent pulling through the fan blade material. In using the hinged yoke version of the air cleaning device 5, one opens the yoke latch 105, and places the yoke of the air cleaning device 95 around an appropriate part of a drive shaft or spindle, clear of obstructions. The hinged yoke 95 is then closed around the drive shaft or spindle, the latch 105 is closed and locked, and all four perimeter bolts 115 are tightened. The perimeter bolts 115 may contain lock washers, nylon inserts, or an anti-loosening compound to prevent the perimeter bolts 115 from backing out of the hinged yoke 95.

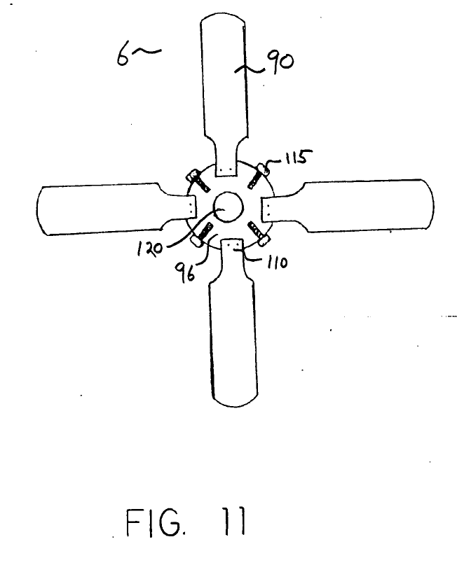

A modification to the air cleaning device 5 is shown in FIG. 11. This modified air cleaning device 6 contains a fixed yoke 96. The fixed yoke 96 of this device is for placement on an open end of a drive shaft that is free of obstructions such as pulleys, sprockets, or drive mechanisms. The yoke 96 connects the fan blades 90 to a drive shaft. In this embodiment, the drive shaft is round, and the opening 120 in the fixed yoke 96 is also round, and of the same diameter as the drive shaft. The opening 120 in the fixed yoke 96 is made to accommodate a drive shaft. The fixed yoke 96 is made of a metal such as hardened steel, stainless steel or titanium. The fixed yoke 96 also contains bolts 115 contained in threaded holes that traverse the diameter of the fixed yoke 96 and make contact with the drive shaft or spindle upon which the yoke is attached. The bolts 115 are tightened once the fixed yoke 96 is in place along the drive shaft or spindle, and serve to apply pressure to the drive shaft or spindle and thus secure the modified air cleaning device 6 to the drive shaft or spindle. The bolts 115 are preferably made from hardened steel to withstand high bolt torque. The flexible fan blades 90 are attached to the fixed yoke 96 with metal fasteners 110 such as bolts, rivets or screws. The metal fasteners 110 contain a head of sufficient size and shape as to prevent pulling through the fan blade material. In using the fixed yoke version of the modified air cleaning device 6, one places the fixed yoke 96 of the modified air cleaning device 6 around an appropriate end of a drive shaft or spindle, clear of obstructions. The fixed yoke 96 is slid to an appropriate point along the drive shaft or spindle, and all perimeter bolts 115 are tightened. The perimeter bolts 1 15 may contain lock washers, nylon inserts, or an anti-loosening compound to prevent the perimeter bolts 115 from backing out of the fixed yoke 96.

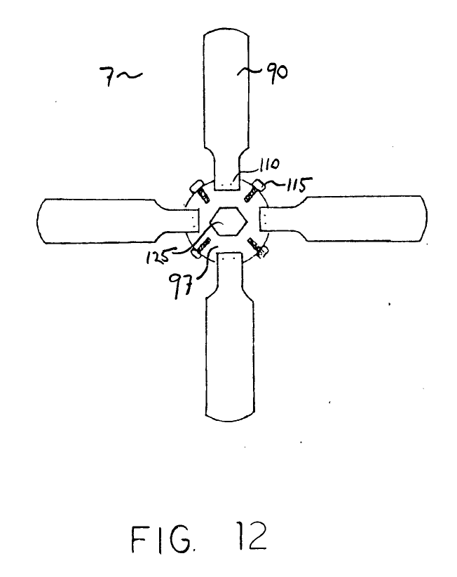

A further modification to the air cleaning device 5 is shown in FIG. 12. This modified air cleaning device 7 contains a fixed yoke 97. The fixed yoke 97 of this device is for placement on an open end of a drive shaft that is free of obstructions such as pulleys, sprockets, or drive mechanisms. In this embodiment, the drive shaft is hexagonal, and the opening 125 in the fixed yoke 97 is also hexagonal, and of the same size as the drive shaft. The opening 125 in the fixed yoke 97 is made to accommodate a drive shaft or spindle. The fixed yoke 97 is made of a metal such as hardened steel, stainless steel or titanium. The fixed yoke 97 also contains four bolts 115 contained in threaded holes that traverse the diameter of the fixed yoke 97 and make contact with the drive shaft or spindle upon which the yoke is attached. The bolts 115 are tightened once the fixed yoke 97 is in place along the drive shaft or spindle, and serve to apply pressure to the drive shaft or spindle and thus secure the modified air cleaning device 7 to the drive shaft or spindle. The bolts 115 are preferably made from hardened steel to withstand high bolt torque. The flexible fan blades 90 are attached to the fixed yoke 97 with metal fasteners 110 such as bolts, rivets or screws. The metal fasteners 110 contain a head of sufficient size and shape as to prevent pulling through the fan blade material. In using the fixed yoke version of the modified air cleaning device 7, one places the fixed yoke 97 of the modified air cleaning device 7 around an appropriate end of a drive shaft or spindle, clear of obstructions. The fixed yoke 97 is slid to an appropriate point along the drive shaft or spindle, and all perimeter bolts 115 are tightened. The perimeter bolts 115 may contain lock washers, nylon inserts, or an anti-loosening compound to prevent the perimeter bolts 115 from backing out of the fixed yoke 96.

While the present invention has been described by reference to the above-mentioned embodiments, certain modifications and variations will be evident to those of ordinary skill in the art. These are intended to be comprehended within the scope of the claimed invention.

1-7. (canceled)

8. A mechanical cleaning device for mounting on a cutting blade, said mechanical cleaning device comprising:
an expandable metal clamp for mounting to the cutting blade, said expandable metal clamp having two flanges;
a bolt, engaging said two flanges, to constrict said expandable metal clamp around the cutting blade; and
a replaceable brush head comprising bristles, said replaceable brush head being mountable to said expandable metal clamp.

9. The device as claimed in claim 8, wherein said bristles are made of monofilament.

10. A mechanical cleaning device for mounting on a cutting blade, said mechanical cleaning device comprising:
an expandable metal clamp for mounting to the cutting blade;
a bolt to constrict said expandable metal clamp around the cutting blade; and
a replaceable brush head comprising bristles, said replaceable brush head being mountable to said expandable metal clamp;
said bristles being bent in an L shape.

11. The device as claimed in claim 8, wherein said bristles consist essentially of brass.

12. The device as claimed in claim 8, wherein said bristles consist essentially of steel.

13. The device as claimed in claim 8, wherein said replaceable brush head is made from plastic.

14-26. (canceled)

27. The device as clamed in claim 8, wherein said replaceable brush head is mounted on a first side of said expandable metal clamp, said first side being opposite a second side having said flanges.

28. The device as clamed in claim 8, wherein said bolt is positioned substantially parallel to the cutting blade.

29. The device as clamed in claim 8, wherein a portion of said bristles are positioned to be orthogonal to the cutting blade and a portion of said bristles are positioned to be non-orthogonal to the cutting blade.

30. A mechanical mowing deck cleaning device for mounting on a cutting blade associated with a mowing deck, said mechanical cleaning device comprising:
an expandable metal clamp for mounting to the cutting blade; and
a replaceable brush head comprising bristles, said replaceable brush head being mountable to said expandable metal clamp such that substantially all said bristles physically engage the mowing deck.

31. The device as clamed in claim 30, further comprising:
a bolt;
said expandable metal clamp having two flanges;
said bolt engaging said two flanges to constrict said expandable metal clamp around the cutting blade.

32. The device as clamed in claim 31, wherein said replaceable brush head is mounted on a first side of said expandable metal damp, said first side being opposite a second side having said flanges.

33. The device as clamed in claim 31, wherein said bolt is positioned substantially parallel to the cutting blade.

34. The device as clamed in claim 30, wherein a portion of said bristles are positioned to be orthogonal to the cutting blade and a portion of said bristles are positioned to be non-orthogonal to the cutting blade.

35. The device as clamed in claim 30, wherein said bristles are bent in an L shape.
